(19) United States
(12) Patent Application Publication
(10) Pub. No.: US 2015/0186446 A1
(43) Pub. Date: Jul. 2, 2015

(54) IDENTIFYING CHANGES TO QUERY RESULTS SYSTEM AND METHOD

(71) Applicant: International Business Machines Corporation, Armonk, NY (US)

(72) Inventors: Trina M. Burkett, Morrisville, NC (US); Morris S. Johnson, JR., Cary, NC (US); Aditya Matange, Cary, NC (US); Jarett Stein, Bryn Mawr, PA (US)

(73) Assignee: International Business Machines Corporation, Armonk, NY (US)

(21) Appl. No.: 14/225,664

(22) Filed: Mar. 26, 2014

Related U.S. Application Data
(63) Continuation of application No. 14/145,149, filed on Dec. 31, 2013.

(51) Int. Cl. G06F 17/30

(52) U.S. Cl. CPC G06F 17/30368; G06F 17/30525; G06F 17/30457

(57) ABSTRACT

A method, computer program product, and computer system for identifying a first set of query results generated from a first query executed at a first time. A second set of query results generated from the first query executed at a second time is identified. One or more changes between the first set of query results and the second set of query results is determined. A second query is generated based upon, at least in part, the one or more changes.

### BACKGROUND

When managing a project or making decisions, it may be beneficial to keep track of any changes in the information associated with the project. For example, while tracking project changes across a software life cycle, queries may be run that show planned development features in an upcoming release. At a given point, the query may be run and the results may be used to make project planning decisions for the upcoming release. The results from the same query may change over time as development items' field values change (e.g., release may change from 1.0 to 2.0, owning team may change from TeamA to TeamB, etc.), which may or may not alter the project planning decisions depending on the changes.

### BRIEF SUMMARY OF DISCLOSURE

In one implementation, a method, performed by one or more computing devices, may include but is not limited to identifying, at a computing device, a first set of query results generated from a first query executed at a first time. A second set of query results generated from the first query executed at a second time may be identified. One or more changes between the first set of query results and the second set of query results may be determined. A second query may be generated based upon, at least in part, the one or more changes.

One or more of the following features may be included. The second query may include a frequency of change for one or more parameters. The second query may include an identification of a party that implemented the one or more changes. A selection of one or more query parameters to include when determining the one or more changes between the first set of query results and the second set of query results may be received. A rendering of the second set of query results may be annotated to indicate an occurrence of the one or more changes. A rendering of a result set for the second query may be annotated to describe the one or more changes. Generating the second query may include rendering one or more results from the first set of query results that are missing from the second set of query results.

In another implementation, a computing system includes a processor and a memory configured to perform operations that may include but are not limited to identifying a first set of query results generated from a first query executed at a first time. A second set of query results generated from the first query executed at a second time may be identified. One or more changes between the first set of query results and the second set of query results may be determined. A second query may be generated based upon, at least in part, the one or more changes.

One or more of the following features may be included. The second query may include a frequency of change for one or more parameters. The second query may include an identification of a party that implemented the one or more changes. A selection of one or more query parameters to include when determining the one or more changes between the first set of query results and the second set of query results may be received. A rendering of the second set of query results may be annotated to indicate an occurrence of the one or more changes. A rendering of a result set for the second query may be annotated to describe the one or more changes. Generating the second query may include rendering one or more results from the first set of query results that are missing from the second set of query results.

In another implementation, a computer program product resides on a computer readable storage medium that has a plurality of instructions stored on it. When executed by a processor, the instructions cause the processor to perform operations that may include but are not limited to identifying a first set of query results generated from a first query executed at a first time. A second set of query results generated from the first query executed at a second time may be identified. One or more changes between the first set of query results and the second set of query results may be determined. A second query may be generated based upon, at least in part, the one or more changes.

One or more of the following features may be included. The second query may include a frequency of change for one or more parameters. The second query may include an identification of a party that implemented the one or more changes. A selection of one or more query parameters to include when determining the one or more changes between the first set of query results and the second set of query results may be received. A rendering of the second set of query results may be annotated to indicate an occurrence of the one or more changes. A rendering of a result set for the second query may be annotated to describe the one or more changes. Generating the second query may include rendering one or more results from the first set of query results that are missing from the second set of query results.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is an illustrative diagrammatic view of a query process coupled to a distributed computing network according to one or more implementations of the present disclosure;

FIG. 2 is a diagrammatic view of a client electronic device of FIG. 1 according to one or more implementations of the present disclosure;

FIG. 3 is an illustrative flowchart of the query process of FIG. 1 according to one or more implementations of the present disclosure;

FIG. 4 is an illustrative diagrammatic view of a screen image displayed by the query process of FIG. 1 according to one or more implementations of the present disclosure;

FIG. 5 is an illustrative diagrammatic view of a screen image displayed by the query process of FIG. 1 according to one or more implementations of the present disclosure;

FIG. 6 is an illustrative diagrammatic view of a screen image displayed by the query process of FIG. 1 according to one or more implementations of the present disclosure; and

FIG. 7 is an illustrative diagrammatic view of a screen image displayed by the query process of FIG. 1 according to one or more implementations of the present disclosure.

Like reference symbols in the various drawings indicate like elements.

### DETAILED DESCRIPTION

### System Overview:

As will be appreciated by one skilled in the art, the present disclosure may be embodied as a method, system, or computer program product. Accordingly, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of this document, a computer-usable or computer-readable, storage medium may be any tangible medium that can contain or store a program for use by or in connection with the instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. The computer readable program code may be transmitted using any appropriate medium, including but not limited to the internet, wireline, optical fiber cable, RF, etc. A computer readable signal medium may be any computer readable medium that is not a computer readable storage medium and that can communicate, propagate, or transport a program for use by or in connection with an instruction execution system, apparatus, or device.

Computer program code for carrying out operations of the present disclosure may be written in an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript or PERL. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider).

The flowchart and block diagrams in the figures illustrate the architecture, functionality, and operation of possible implementations of apparatus (systems), methods and computer program products according to various implementations of the present disclosure. It will be understood that each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some alternative implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

The computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

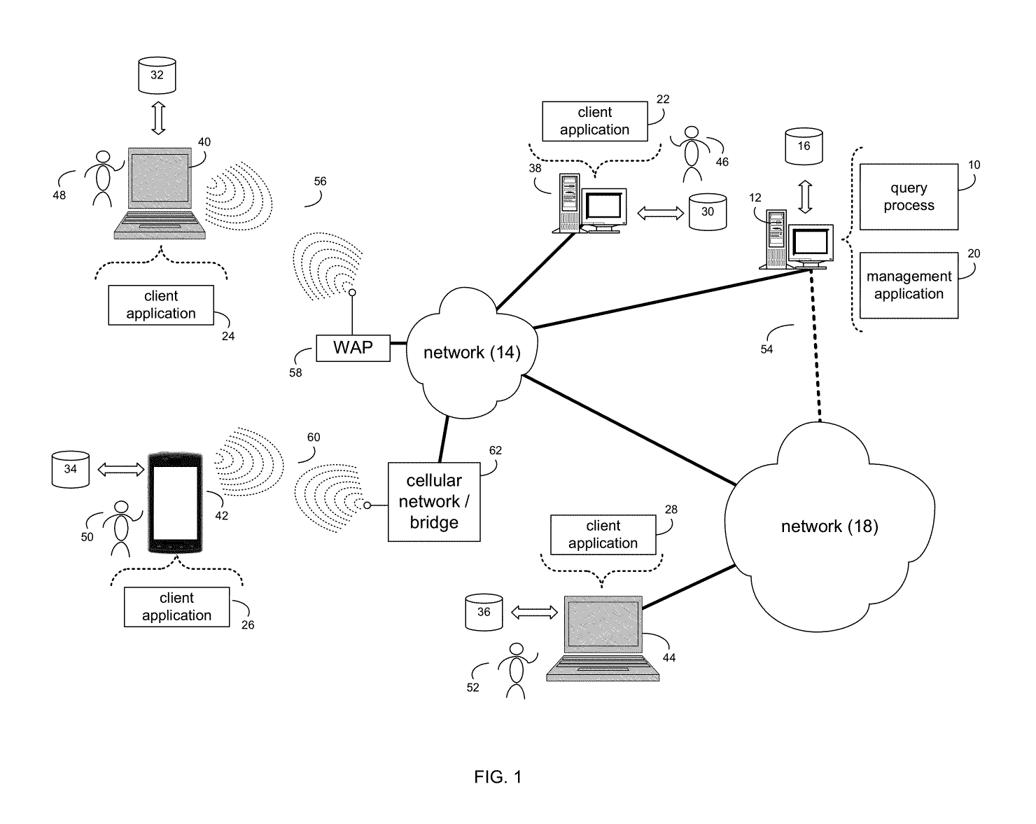

Referring to FIG. 1, there is shown query process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, query process 10 may identify a first set of query results generated from a first query executed at a first time. A second set of query results generated from the first query executed at a second time may be identified. One or more changes between the first set of query results and the second set of query results may be determined. A second query may be generated based upon, at least in part, the one or more changes.

The instruction sets and subroutines of query process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Computer 12 may include a data store, such as a database (e.g., relational database, object-oriented database, triplestore database, etc.) and may be located within any suitable memory location, such as storage device 16 coupled to computer 12. Any data described throughout the present disclosure may be stored in the data store. In some implementations, computer 12 may utilize a database management system such as, but not limited to, “My Structured Query Language” (MySQL®) in order to provide multi-user access to one or more databases, such as the above noted relational database. The data store may also be a custom database, such as, for example, a flat file database or an XML database. Any other form(s) of a data storage structure and/or organization may also be used. Query process 10 may be a component of the data store, a stand alone application that interfaces with the above noted data store and/or an applet/application that is accessed via client applications 22, 24, 26, 28. The above noted data store may be, in whole or in part, distributed in a cloud computing topology. In this way, computer 12 and storage device 16 may refer to multiple devices, which may also be distributed throughout the network.

Computer 12 may execute a management application (e.g., management application 20), examples of which may include, but are not limited to, e.g., an IT service application (e.g., development and integration, IT management, knowledge management, program management, quality management, software product support services), a software quality and life-cycle tool application, a software development team collaboration tool application, a clinical decision support application, a healthcare application, a resource management application, or other application that allows for managing aspects of work, such as plans, tasks, revision control, build management, and reports, and/or querying of local and remote information. Query process 10 and/or management application 20 may be accessed via client applications 22, 24, 26, 28. Query process 10 may be a stand alone application, or may be an applet/application/script that may interact with and/or be executed within management application 20, a component of management application 20, and/or one or more of client applications 22, 24, 26, 28. Management application 20 may be a stand alone application, or may be an applet/application/script that may interact with and/or be executed within query process 10, a component of query process 10, and/or one or more of client applications 22, 24, 26, 28. One or more of client applications 22, 24, 26, 28 may be a stand alone application, or may be an applet/application/script that may interact with and/or be executed within and/or be a component of query process 10 and/or management application 20. Examples of client applications 22, 24, 26, 28 may include, but are not limited to, e.g., an IT service application (e.g., development and integration, IT management, knowledge management, program management, quality management, software product support services), a software quality and life-cycle tool application, a software development team collaboration tool application, a clinical decision support application, a healthcare application, a resource management application, or other application that allows for managing aspects of work, such as plans, tasks, revision control, build management, and reports, and/or querying of local and remote information and/or querying of local and remote information, a standard and/or mobile web browser, an email client application, a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36 coupled to client electronic devices 38, 40, 42, 44, may be executed by one or more processors (not shown) and one or more memory architectures (not shown) incorporated into client electronic devices 38, 40, 42, 44.

Storage devices 30, 32, 34, 36 may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Android™, Apple® iOS®, Mac® OS X®; Red Hat® Linux®, or a custom operating system.

One or more of client applications 22, 24, 26, 28 may be configured to effectuate some or all of the functionality of query process 10 (and vice versa). Accordingly, query process 10 may be a purely server-side application, a purely client-side application, or a hybrid server-side/client-side application that is cooperatively executed by one or more of client applications 22, 24, 26, 28 and/or query process 10.

One or more of client applications 22, 24, 26, 28 may be configured to effectuate some or all of the functionality of management application 20 (and vice versa). Accordingly, management application 20 may be a purely server-side application, a purely client-side application, or a hybrid server-side/client-side application that is cooperatively executed by one or more of client applications 22, 24, 26, 28 and/or management application 20. As one or more of client applications 22, 24, 26, 28, query process 10, and management application 20, taken singly or in any combination, may effectuate some or all of the same functionality, any description of effectuating such functionality via one or more of client applications 22, 24, 26, 28, query process 10, management application 20, or combination thereof, and any described interaction(s) between one or more of client applications 22, 24, 26, 28, query process 10, management application 20, or combination thereof to effectuate such functionality, should be taken as an example only and not to limit the scope of the disclosure.

Users 46, 48, 50, 52 may access computer 12 and query process 10 (e.g., using one or more of client electronic devices 38, 40, 42, 44) directly through network 14 or through secondary network 18. Further, computer 12 may be connected to network 14 through secondary network 18, as illustrated with phantom link line 54. Query process 10 may include one or more user interfaces, such as browsers and textual or graphical user interfaces, through which users 46, 48, 50, 52 may access query process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, and/or Bluetooth™ device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

Some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

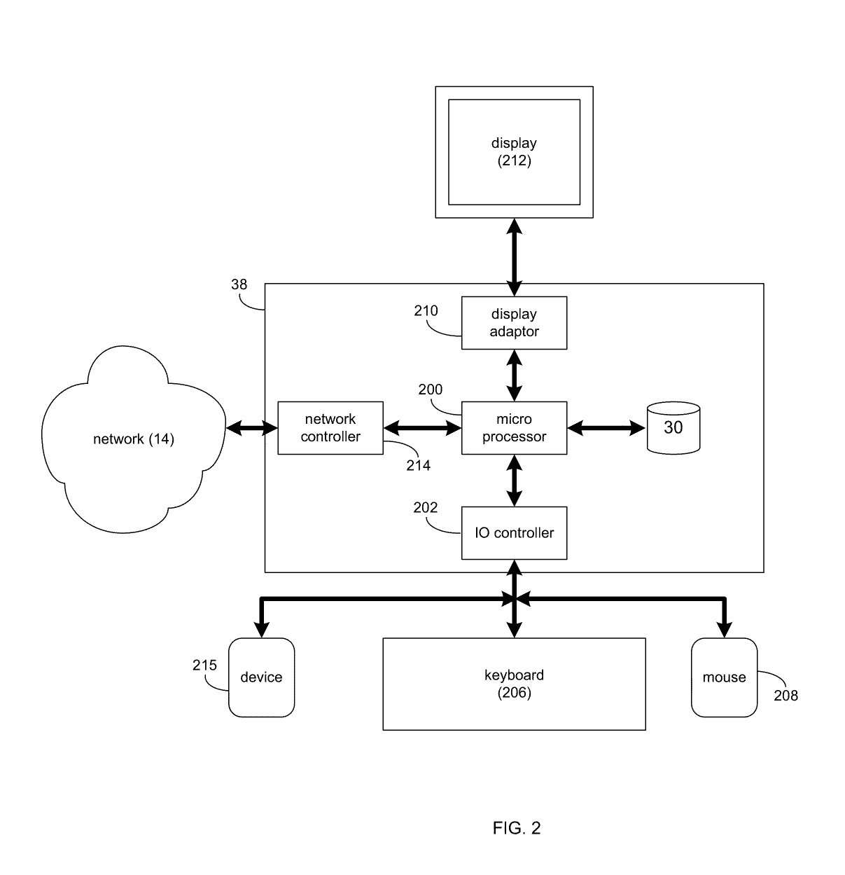

Referring also to FIG. 2, there is shown a diagrammatic view of client electronic device 38. While client electronic device 38 is shown in this figure, this is for illustrative purposes only and is not intended to be a limitation of this disclosure, as other configurations are possible. For example, any computing device capable of executing, in whole or in part, query process 10 may be substituted for client electronic device 38 within FIG. 2, examples of which may include but are not limited to computer 12 and/or client electronic devices 40, 42, 44.

Client electronic device 38 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device (e.g., storage device 30). An I/O controller (e.g., I/O controller 202) may be configured to couple microprocessor 200 with various devices, such as keyboard 206, pointing/selecting device (e.g., mouse 208), custom device (e.g., device 215), USB ports (not shown), and printer ports (not shown). A display adaptor (e.g., display adaptor 210) may be configured to couple display 212 (e.g., CRT or LCD monitor(s)) with microprocessor 200, while network controller/adaptor 214 (e.g., an Ethernet adaptor) may be configured to couple microprocessor 200 to the above-noted network 14 (e.g., the Internet or a local area network).

### The Query Process:

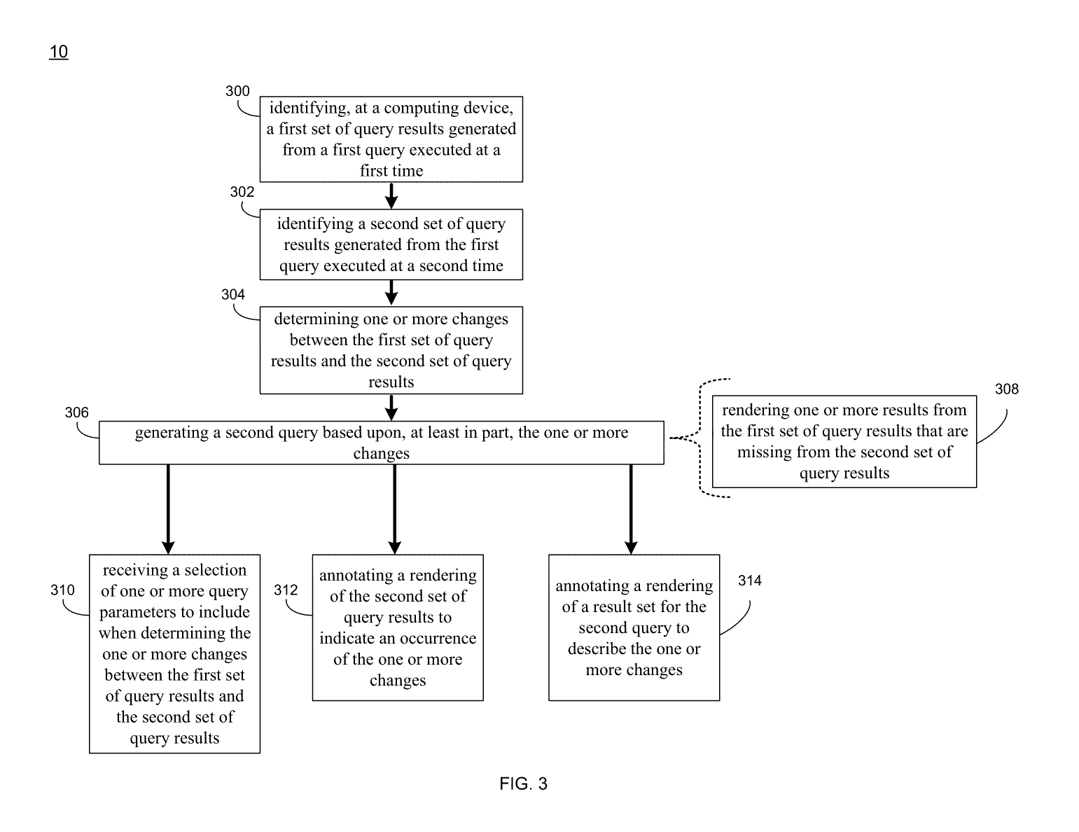

As discussed above and referring also to FIGS. 3-7, query process 10 may identify 300 a first set of query results generated from a first query executed at a first time. Query process 10 may identify 302 a second set of query results generated from the first query executed at a second time. Query process 10 may determine 304 one or more changes between the first set of query results and the second set of query results. Query process 10 may generate 306 a second query based upon, at least in part, the one or more changes.

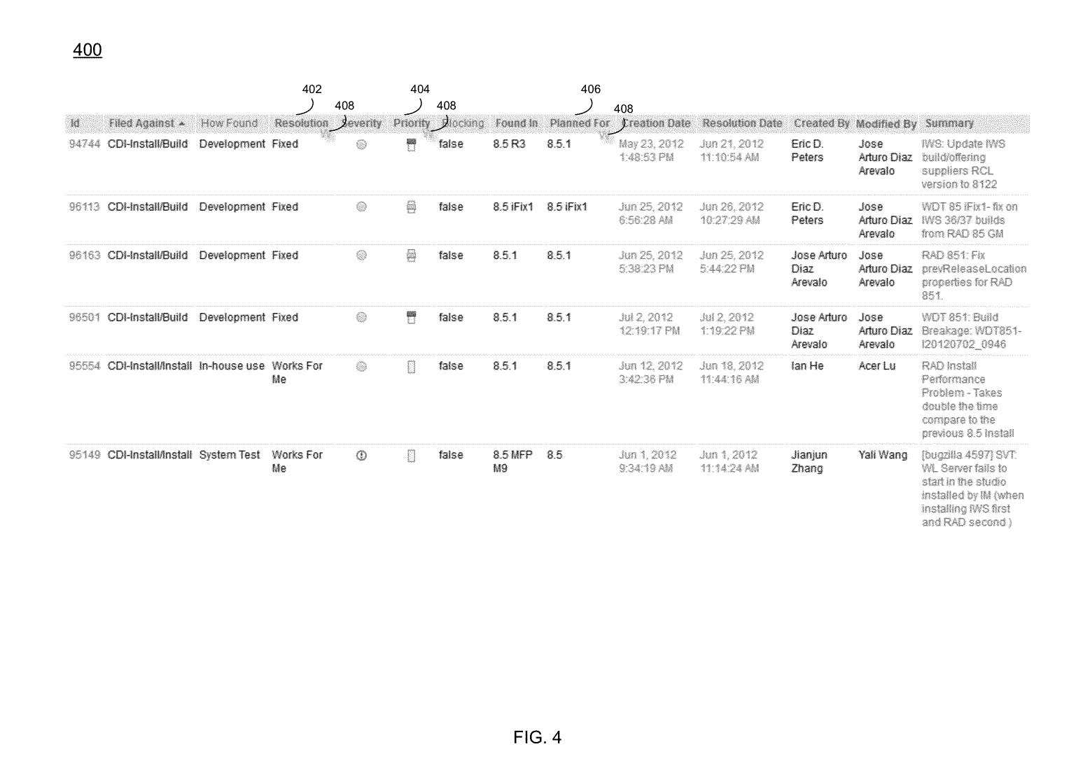

In some implementations, query process 10 may identify 300 a first set of query results generated from a first query executed at a first time. For instance, and referring at least to FIG. 4, an example first set of query results generated from a first query executed at a first time (e.g., 25 Jul. 2013) may be identified 300 by query process 10, and is shown at an example user interface (e.g., user interface 400) associated with query process 10. The first set of query results may be time stamped and stored by query process 10 at, e.g., storage device 16. In the example, six results have been returned and identified 300 based upon, at least in part, the query parameters of the first query executed at 25 Jul. 2013. As an example, the first query may include one or more criteria (query parameters), one of which may include showing all defect severities except the lowest (minor/sev4).

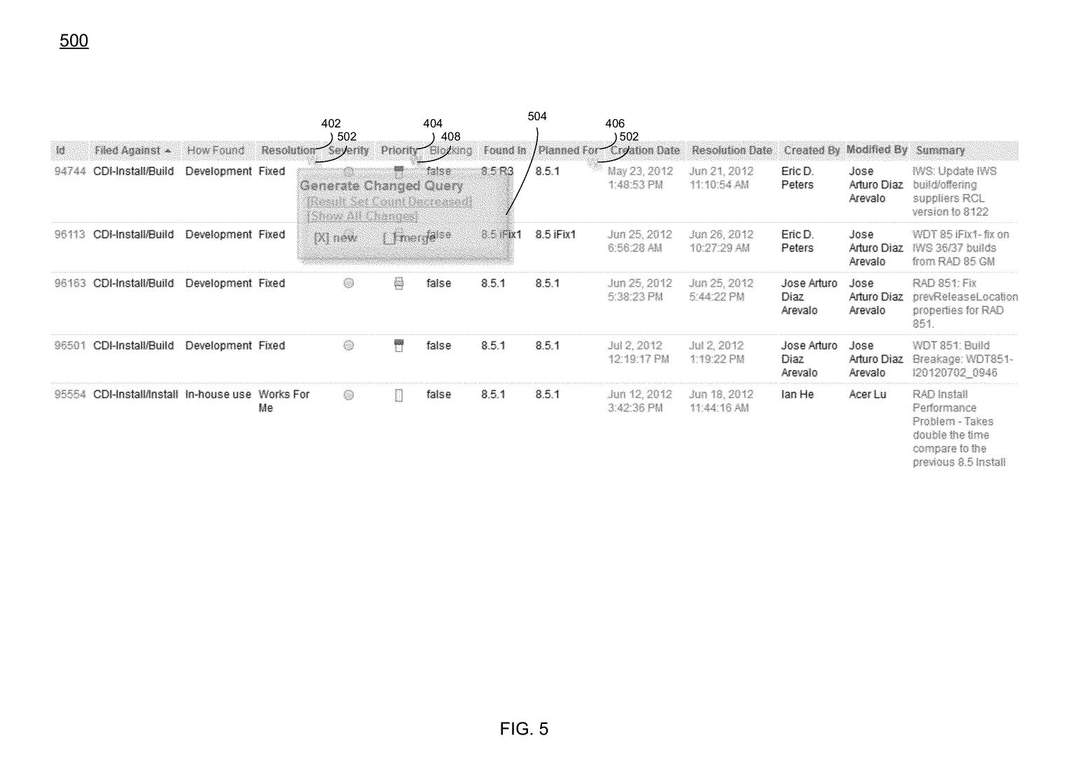

In some implementations, query process 10 may identify 302 a second set of query results generated from the first query executed at a second time. For instance, and referring at least to FIG. 5, an example second set of query results generated from the first query executed at a second time (e.g., 25 Aug. 2013) may be identified 302 by query process 10, and is shown at the example user interface (e.g., user interface 500) associated with query process 10. The second set of query results may be time stamped and stored by query process 10 at, e.g., storage device 16. In the example, five results have been returned and identified 302 based upon, at least in part, the query parameters of the first query executed at 25 Aug. 2013.

In some implementations, query process 10 may determine 304 one or more changes between the first set of query results and the second set of query results. For example, in some implementations, query process 10 may access and compare the first and second set of query results stored at storage device 16 to determine 304 any changes (e.g., differences) that may exist between each set of query results.

In some implementations, query process 10 may receive 310 a selection of one or more query parameters to include when determining 304 the one or more changes between the first set of query results and the second set of query results. For instance, at least a portion of the user interface (not shown) associated with query process 10 may enable a user (e.g., user 46) to select one or more query parameters/fields to be included when comparing each set of query results. For example, referring once again to FIG. 4, assume for example purposes only that query process 10 has received 310 from user 46 a selection of query parameter 402 (e.g., “Resolution”), query parameter 404 (e.g., “Priority”), and query parameter 406 (e.g., “Planned For”). In the example, query process 10 may access and compare the first and second set of query results stored at storage device 16 to determine 304 any changes (e.g., differences) that may exist between query parameters 402, 404, and 406 respectively associated with each set of query results. In some implementations, an annotation (e.g., blue “W” 408) may appear proximate to each respective column of parameters to denote those are the parameters which are being compared to determine 304 any changes. In the example, those parameters/fields not selected by user 46 may not be included when comparing the first and second set of query results stored at storage device 16 to determine 304 any changes. In some implementations, a selection for all parameters may be received 310 by query process 10 to determine 304 any changes.

In some implementations, a rendering of the second set of query results may be annotated 312 by query process 10 to indicate an occurrence of the one or more changes. For example, and referring again to FIG. 5, five results have been returned and identified 302 based upon, at least in part, the query parameters of the first query executed at 25 Aug. 2013. In the example, query process 10 may annotate 312 the rendering of the second set of query results to indicate that query process 10 has determined 304 that at least one change has occurred for query parameters 402, 404, and 406 respectively associated with each set of query results. In the example, the change has occurred for query parameters 402 and 406, annotated 312 by, e.g., gold “W” 502 and 504. In the example, because no changes were determined 304 to occur for query parameter 404, blue “W” 408 remains. It will be appreciated that other types of annotations may be used without departing from the scope of this disclosure.

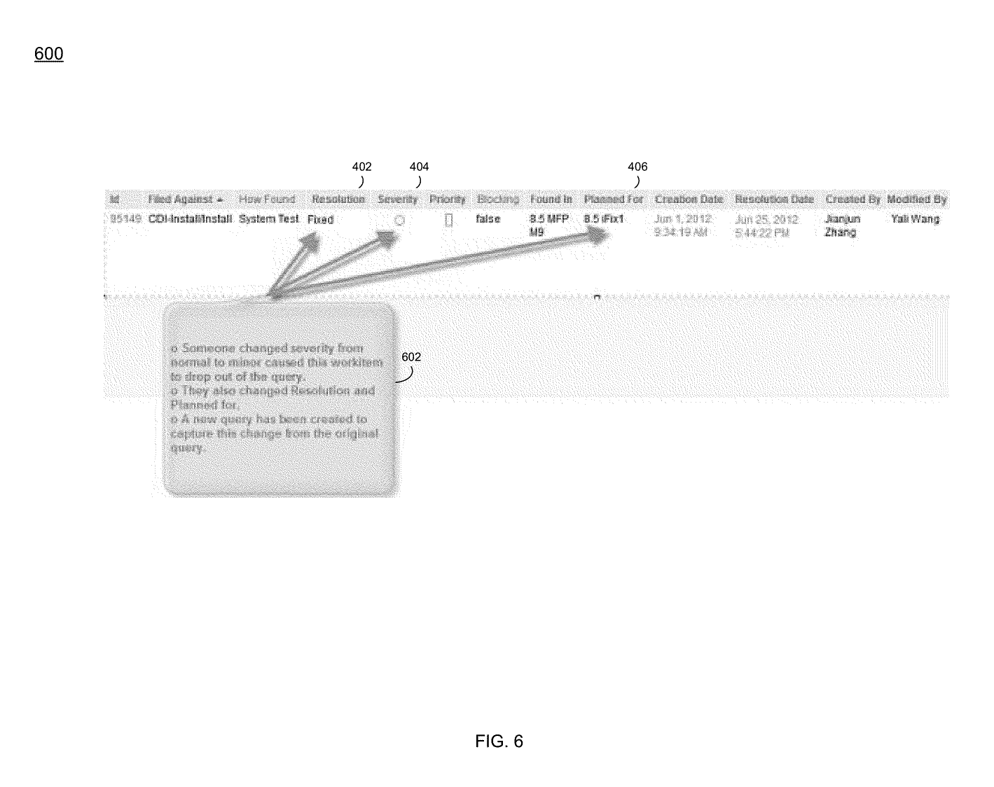

In some implementations, query process 10 may generate 306 a second query based upon, at least in part, the one or more changes. For instance, assume for example purposes only that pop-up window 504 (or other object) is rendered by query process 10 in response to determining 304 changes have occurred. Query process 10 may enable user 46 to use a pointing device (e.g., mouse 208) to select pop-up window 504, which may result in query process 10 generating 306 a second query based upon, at least in part, the one or more changes. For instance, and referring at least to FIG. 6, an example result set for a second query based upon, at least in part, the one or more changes is generated 306, and is shown at the example user interface (e.g., user interface 600) associated with query process 10. In some implementations, the second query may include a new (or merged) query based upon, at least in part, what values changed between the first and second set of query results.

In some implementations, generating 306 the second query may include query process 10 rendering 308 one or more results from the first set of query results that are missing from the second set of query results. For example, and referring again to FIG. 4, the example first set of six query results generated from the first query executed at the first time have been returned and identified 300 based upon, at least in part, the query parameters of the first query executed at 25 Jul. 2013. In the example, and referring again to FIG. 5, the example second set of five query results generated from the first query executed at the second time have been returned and identified 302 based upon, at least in part, the query parameters of the first query executed at 25 Aug. 2013. Further in the example, and referring again to FIG. 6, the query result for ID 95149 is rendered 308 in the results for the second query, since ID 95149 is found in the first set of query results, but is not found in the second set of query results.

In some implementations, a rendering of the result set for the second query may be annotated 314 by query process 10 to describe the one or more changes. For instance, assume for example purposes only that pop-up window 602 (or other object) is rendered by query process 10 to annotate 314 the result set for the second query. Pop-up window 602 may be rendered by user 46 “hovering” a pointer of mouse 208 over the rendering, may be rendered automatically, or by other techniques. In the example, query process 10 may describe in pop-up window 602 one or more of the changes between the first and second set of query results (for query parameters/fields to be included when comparing each set of query results) that has caused ID 95149 not to appear in the second set of query results. In the example, the changes included a change to the “Resolution”, “Severity”, and “Planned For” parameters/fields.

In some implementations, the second query may include a frequency of change for one or more parameters. For instance, continuing with the above example, pop-up window 602 describing the one or more of the changes between the first and second set of query results (for query parameters/fields to be included when comparing each set of query results) that has caused ID 95149 not to appear in the second set of query results may also include how often one or more of the changes has occurred. For example, pop-up window 602 may also describe how the “Severity” parameter/field was changed, e.g., ten times in a six week period. Identification of the frequency of change may be an early warning sign of a problem with process, planning or culture that may need to be addressed, e.g., by a project supervisor.

In some implementations, the second query may include an identification of a party that implemented the one or more changes. For instance, continuing with the above example, pop-up window 602 describing the one or more of the changes between the first and second set of query results (for query parameters/fields to be included when comparing each set of query results) that has caused ID 95149 not to appear in the second set of query results may also include the user that implemented each change. For example, pop-up window 602 may also describe that the “Severity” parameter/field was changed, e.g., ten times in a six week period, and that user 46 changed the “Severity” parameter/field eight times, and user 48 changed the “Severity” parameter/field two times. In some implementations, pop-up window 602 may also describe which parameters/fields are changing the most and lease between the first and second set of query results.

In some implementations, one or more items in the result set may include its own state (e.g., linked item). For instance, assume for example purposes only that a work item also has a dependant task/work item. If the dependent work item changed, even when the actual rendered and viewable returned result set does not, query process 10 may check if changes to one of the linked items has occurred, and may still notify the user if they watched that column. Thus, in this example, the column watched (e.g., the query parameters/fields to be included when comparing each set of query results) may be any result set that returns one of the linked items (e.g., “depend on”, “parent”, “child”, etc.). In some implementations, if that underlying linked task has changed, the user may be notified by query process 10 (e.g., email, pop-up window, etc.).

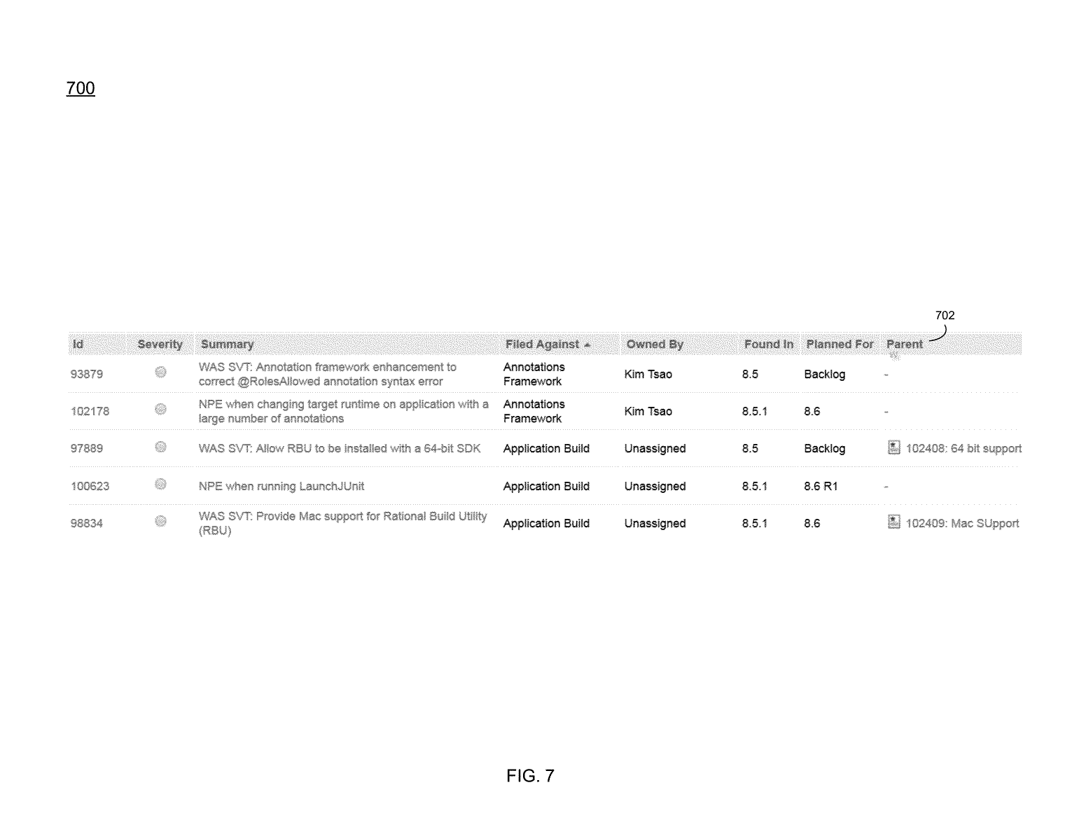

In some implementations, and referring at least to FIG. 7, an example user interface (e.g., user interface 700) associated with query process 10 is shown where a user may review items linked to the result delta, or the second query. In the example, if user 46 were to make a change within parent user story 102408, a watch warning for that column (e.g., parameter/field 702) may be generated along with a query (e.g., the above-noted second query) that shows the linked item that changed.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, and combinations thereof) are possible without departing from the scope of the disclosure defined in the appended claims.

What is claimed is:

1. A computer-implemented method comprising:
identifying, at a computing device, a first set of query results generated from a first query executed at a first time;
identifying a second set of query results generated from the first query executed at a second time;
determining one or more changes between the first set of query results and the second set of query results; and
generating a second query based upon, at least in part, the one or more changes.

2. The computer-implemented method of claim 1 wherein the second query includes a frequency of change for one or more parameters.

3. The computer-implemented method of claim 1 wherein the second query includes an identification of a party that implemented the one or more changes.

4. The computer-implemented method of claim 1 further comprising receiving a selection of one or more query parameters to include when determining the one or more changes between the first set of query results and the second set of query results.

5. The computer-implemented method of claim 1 further comprising annotating a rendering of the second set of query results to indicate an occurrence of the one or more changes.

6. The computer-implemented method of claim 1 further comprising annotating a rendering of a result set for the second query to describe the one or more changes.

7. The computer-implemented method of claim 1 wherein generating the second query includes rendering one or more results from the first set of query results that are missing from the second set of query results.

8.-20. (canceled)
